(19) United States
(12) Patent Application Publication
(10) Pub. No.: US 2026/0097513 A1
(43) Pub. Date: Apr. 9, 2026

(54) GRIPPER DEVICE AND GRIPPING METHOD

(71) Applicant: HAVER & BOECKER OHG, Oelde (DE)

(72) Inventor: Willi VOLLENKEMPER, Oelde (DE)

(21) Appl. No.: 19/111,903

(22) PCT Filed: Sep. 14, 2023
(86) PCT No.: PCT/EP2023/075293

§ 371 Date: Mar. 14, 2025

(30) Foreign Application Priority Data
Sep. 16, 2022 (DE) 10 2022 123 766.4

(51) Int. Cl. B25J 9/16; B25J 13/08; B65H 3/06

(52) U.S. Cl. CPC B25J 9/1697; B25J 13/088; B65H 3/0684; B25J 9/163; B65H 2405/575; B65H 2553/25; B65H 2701/191

(57) ABSTRACT

A gripper device for gripping individual units, including a gripper unit and a holder unit, the gripper unit has a contact section for gripping an individual unit and the holder device includes a holder element. A free end of the contact section includes a lifting device for lifting an individual gripped unit, such that the contact section is shiftable underneath the individual gripped unit. The gripper unit also includes a fixing device. The handling device includes a robot device with a robotic arm and a gripper device. The system for gripping and transferring individual units includes a handling device and at least one control device. In the method, the gripper unit reaches an edge of the individual gripped unit and the lifting device raises the individual unit to move the contact section underneath the individual gripped unit. The individual unit is clamped between the fixing device and the contact section.

The present invention relates to a gripper device for gripping individual units, in particular for gripping an empty sack or an empty sack stack, comprising at least one gripper unit and at least one holder unit. The gripper unit has at least one contact section for an individual unit to be gripped and the holder device comprises at least one holder element. The present invention also relates to a handling device with such a gripper device, a system comprising such a handling device, and a method for gripping at least one individual unit, in particular at least one empty sack or at least one empty sack stack, using such a system.

Various devices for gripping and transferring or transporting objects, in particular stacked objects, are known in the prior art, e.g., DE 691 00 158 T2, DE 10 2012 009 649 A1 and DE 10 2019 220 027 A1. For example, when transporting empty sacks, e.g., in the area of packing systems for filling bulk material into sacks, empty sacks lying flat can be lifted with the help of suction pads and transferred to a specific location and/or another unit. However, the disadvantage is that only individual sacks but no bundles of sacks can be lifted by means of the suction pads.

A bundle of sack could indeed be held with a conventional gripper, for example by means of a pincer gripper, but the problem here is that such a gripper cannot independently grip sacks or stacks of sacks layered on a pallet, for example, because the bundles do not protrude freely beyond either side. This means that a conventional gripper cannot automatically grip sacks or bundles of sacks lying flat.

It is therefore the object of the present invention to provide a gripper which can pick up individual objects and also stacks or bundles of objects independently.

This object is achieved by a gripper device with the features of claim 1, by a handling device with the features of claim 19, by a system with the features of claim 20 and by a method with the features of claim 23. Preferred further developments of the invention are the subject matter of the subclaims. Further advantages and features of the present inventions are apparent from the general description and the description of the exemplary embodiment.

The gripper device according to the invention is suitable for gripping individual units, in particular for gripping an empty sack and/or an empty sack stack and/or the like, and comprises at least one gripper unit and at least one holder unit, wherein the gripper unit has at least one contact section for an individual unit to be gripped, and wherein the holder device comprises at least one holder element. At least one free end of the contact section comprises at least one lifting device for lifting an individual unit to be gripped at least in sections, so that the contact section can be shifted at least in sections underneath the individual unit to be gripped.

In this case, an individual unit is in particular an individual object or, depending on the configuration, a stack of objects and/or a bundle of objects, in particular at least one individual empty sack or an empty sack lying flat and/or a stack of sacks or an empty sack stack.

The individual units can in particular be piece goods or objects, which can preferably be provided in stacks or bundles on a storage surface. These individual units or bundles of objects are stacked or layered as individual units, in particular in an offset manner.

Thus, an individual unit can be, for example, an empty sack, for example as used for filling bulk goods. In particular, it is intended that the individual units are substantially flexible, at least in sections. For example, any empty sacks or bags such as valve sacks, FFS sacks, open-mouth sacks or even bundles of paper bags or the like can also be picked up by the gripper device and transferred to another location.

Preferably, a bundle or a stack of objects as an individual unit also has a certain flexibility. For example, bundles of newspapers or stacks of thin or thicker cardboard or stacks of sheets of paper, plastic sheets or the like can also be lifted by the lifting device of the gripper unit, so that the contact section for gripping can be shifted therebelow at least in sections.

The contact section is in particular the region of the gripper device which is shifted underneath an individual unit to be picked up and on which the individual unit to be gripped rests during lifting.

The holder element serves in particular to press down or hold down the individual unit to be gripped or a bundle of objects as an individual unit at least slightly such that the contact section can be moved or shifted underneath the individual unit without the individual unit to be gripped slipping or sliding away and such that the edge of the individual unit or the stack or the bundle is preferably slightly raised.

The gripper device according to the invention offers many advantages. The fact that the contact section comprises at least one lifting device makes it possible to grip individual units such as flat objects, empty sacks and/or empty sack stacks by means of a gripper device and to shift them to another location. This is made possible in that the lifting device lifts the individual unit lying flat on a contact surface at one side or edge of the individual unit such that the free end of the contact section can move underneath the individual unit to be gripped or be shifted a bit underneath the individual unit. Furthermore, the gripper unit comprises at least one fixing device in order to clamp or fix an individual unit between the fixing device (14) and the contact section, in particular when the contact section has been shifted underneath the individual unit to be gripped.

If, for example, the individual units are provided by an empty sack stack, for example with 5, 10 or 15 sacks, the lifting device is used to lift the individual sacks or the empty sack stack as a whole such that the contact section can be shifted at least a bit underneath the empty sack stack. For this purpose, the individual sacks are then preferably separated, so to speak, by the lifting device.

The gripper device according to the invention is particularly suitable for picking up individual objects, and in particular empty sack stacks, which are arranged on an elastic, an inelastic, a hard and/or a rigid surface. Depending on the position of the individual units, different surface properties can also be present for individual ones of the individual units, in particular if the individual objects are arranged on a pallet or another hard contact surface. For example, upper individual units rest on individual units arranged below them, so that the upper individual units rest on a non-rigid or elastic or non-hard surface. The lowest individual units can also rest directly, or separated only by a thin support, on a pallet, for example, and thus on a hard or relatively hard surface.

This makes it possible, unlike conventional gripper devices with suction cups, not only to lift individual sacks or individual units, but also to lift individual units without suction cups and even to grip bundles of objects as individual units, such as empty sack stacks, by means of a gripper device.

Preferably, the lifting device comprises at least one roller. The lifting device or the roller is preferably provided directly at the free end of the contact section and is in particular designed to be turnable or rotatable. It is also possible to provide multiple rollers next to each other, the use of at least one roller being preferred.

Particularly preferably, the roller can be driven. In particular, such a roller of the lifting device can be rotated or driven by means of a motor such as a compressed air motor, an electric motor and/or any other rotary encoder.

Preferably, the roller can be driven by means of at least one motor, with the propulsion of the motor being transmitted to the roller via at least one deflection device. For example, at least one belt can be provided, which transmits the rotation of the motor to a roller. A corresponding connection from the belt to the roller can be provided for this purpose. Depending on the position of the motor, further deflections can also be provided via deflection rollers, drive shafts and/or the like. This can be particularly advantageous if the motor is to be mounted in close proximity below a receiving unit or the connection to a robotic arm, for example for weight reasons, or to optimize the center of gravity. Depending on the configuration, the pivot range of the gripper device can also be improved or reduced by the corresponding arrangement of the motor in a central region.

In advantageous configurations, the roller has at least one contact-imparting structure and/or at least one friction- or adhesion-enhancing surface at least in sections. In particular, it is provided that the roller is designed in such a manner that the “grip” is increased so that an individual unit such as an empty sack or a bundle of empty sacks is lifted by the rotation of the roller.

For example, a contact-imparting structure can be a type of external toothing or a sawtooth-like structure which, for example, when in contact with a bundle of empty sacks or an individual unit, flips through the individual sacks or objects or even multiple at once in order to lift the free edge of the empty sack stack or the individual unit. Such a contact-enhancing structure can also be achieved, for example, by grooves, nubs and/or a brush-like configuration.

A surface that increases frictional adhesion can be provided, for example, by a rubber coating and/or a roughening and/or the like.

In particular, it is preferred that the rotation of the roller or the lifting device causes that individual objects of the individual unit or the individual unit itself are flipped through or flipped open so that the contact section can be inserted or shifted between the contact surface and the individual unit. When a drive belt drives the roller, the movement generated in the upper run can preferably also be used to convey the picked up individual unit backwards during the gripping movement.

Particularly preferably, the gripper unit and the holder unit can be moved relative to each other. Such a configuration that can be moved relative to each other can be provided to be active or passive, for example by a motor-driven drive or also by preloading devices that allow for active movement in at least one direction. By means of an active relative movement of the gripper unit and holder unit to each other it can be effected, for example, that the contact section is moved underneath an individual unit without the entire gripper device being moved in a corresponding direction.

Preferably, the gripper unit and the holder unit are in an articulated and/or resilient relation to each other. In particular, rods and/or actuators connected in an articulated manner can also be provided.

Particularly preferably, the contact section is designed to be telescopic and/or adjustable in length, at least in sections. In particular, the contact section with the lifting device can be designed to be telescopic or adjustable in length in order to be able to pick up different sizes or lengths of individual units, for example when processing sacks and/or stacks of sacks of different sizes or formats. Depending on the configuration, however, differently sized gripper devices can be provided for differently sized individual objects.

It is generally preferred that the gripper device comprises at least one quick-change device in order to achieve quick and easy installation of the gripper device, e.g., on a robotic arm.

In useful configurations, at least one receiving unit is provided, by means of which the gripper unit and the holder unit are connected. The receiving unit is used in particular for fastening the gripper device to a handling device, for example to a robotic arm of a robot device. The holder unit and the gripper unit are connected to each other on the receiving unit, for example, in such a manner that the two components can be arranged in an articulated relation to each other. However, the gripper unit and the holder unit can also be directly connected to each other in an articulated manner and, depending on the configuration, can also be provided in a non-articulated manner.

In useful further developments, at least one actuator is associated with the contact section, the holder device, the holder unit and/or the holder element. Thus, depending on the configuration of an actuator, a movement of the respective component can be effected. If, for example, a preloading device is provided as an actuator, a certain preload or arrangement of the gripper unit to the holder unit can be effected, in particular if the components are provided in an articulated relation to each other.

Preferably, the actuator comprises at least one pneumatic cylinder. Depending on the configuration, other actuators, for example hydraulic cylinders and/or other linearly acting actuators can also be provided. By providing such actuators, it can be achieved, for example, that the gripper unit or the contact section and the holder device are provided with a certain preload in relation to each other. If the gripper device for gripping an individual unit is lowered next to the individual unit, the contact section and the holder element can then preferably move apart against the preload until, for example, a specified end position is reached, which is preferably detected by a limit switch. In particular, an end position is an arrangement of the contact section and holder element in relation to each other that has at least a certain movement buffer in both directions. Depending on the configuration, a maximum deflection of the components in relation to each other can also be defined as the end position.

Preferably, the holder element comprises at least one holding roller. Such a holding roller, at least in sections, can preferably push or press against the individual unit in a downward direction, at least slightly, so that the individual unit does not slip when shifting the contact section. In order to achieve optimum movement of the contact section in the direction below the individual unit, the holding roller then rolls on the individual unit in accordance with the movement of the contact section.

According to the invention, the gripper unit comprises at least one fixing device. In particular, such a fixing device is designed in the form of a fixing punch and/or comprises at least one such fixing punch. This makes it possible that the individual unit, underneath which the contact section has been shifted, is clamped between the fixing device and the contact section. Preferably, such a fixing device, in particular in a configuration as a fixing punch, can be driven in particular by means of a pneumatic cylinder or the like and can also be shifted differently.

Preferably, at least one limit switch is provided, which detects at least one position or deflection, in particular of the contact section and/or the holder device.

In useful further developments, at least one referencing device is provided. Such a referencing device can be provided in particular by at least one bar or at least one rod, which in particular has a specified length. In particular, the referencing device can be used to allow for a height adjustment between the handling device or the robotic arm and the gripper device. In addition, such a referencing device can be used to adjust a movement or an interference contour during the rotation of the gripper device so that the controller can prevent a collision with other components, individual units and/or objects during movement and also during rotation, in particular during simultaneous movement and rotation.

Preferably, at least one hood device is provided, which covers at least the gripper unit and at least one holder unit at least in sections. Such a hood device is intended or designed in particular as a protective hood. In particular, a type of full enclosure of the gripper device is advantageous. In general, a hood device is intended in particular to provide dust protection for the mechanism and collision protection for the mechanism. The mechanism becomes less dirty and maintenance intervals can preferably be extended. In the event of collisions, the mechanism is not damaged, only the hood device is affected. Preferably, at least a certain degree of noise protection is also achieved by such a hood device. Depending on the configuration, insulation may also be provided.

Preferably, at least one fastening device is provided for the hood device. Such a fastening device is received in particular on at least one component of the gripper device.

In useful further developments, at least one display device is associated with the hood device. For example, information can be output in any desired manner via such a display device, and/or the display device can also fulfill design-related functions.

Preferably, the display device comprises at least one illumination device, which in particular is at least partially integrated into the fastening device. Such an illumination device or illumination, in particular LED illumination, can be used in particular as a status display. Preferably, for example, blue can indicate that the unit is running, yellow that a maintenance operation is running or maintenance is required, and red that there is a fault.

Preferably, at least one transparent or free area is provided in the hood device, through which light from the illumination device or generally a display of the display device can be perceived. In particular, such a transparent or free area can represent a logo, wherein, for example, a differently colored logo can then serve as a status display.

The handling device according to the invention comprises at least one robot device with at least one robotic arm and at least one gripper device arranged thereon, as described above. The handling device according to the invention also offers the advantages previously described for the gripper device.

The system according to the invention for gripping and transferring at least one individual unit, in particular at least one empty sack or at least one empty sack stack, comprises at least one handling device as described above and at least one controller.

The controller can preferably be integrated into the handling device or be a part thereof, or can also be provided separately. The system according to the invention also offers the advantages already mentioned above with regard to the gripper device. In particular, it is possible by means of such a system that a gripper device can be moved towards an individual unit, for example by means of a robotic arm, wherein the lifting device of the contact section then lifts the individual unit at at least one edge so that the contact section can be shifted underneath the individual unit. For this purpose, it can in particular be provided that the robotic arm moves the gripper device as a whole in such a direction that the contact section is moved in the direction below the individual unit. Depending on the configuration, however, such a shifting of the contact section can also be effected by a relative, in particular active, movement of the contact section in the direction of the holder device.

Preferably, the system comprises at least one camera device. In particular, a camera device with a height detection means, such as a 3D camera, is advantageous so that the handling device or the robotic arm with the gripper device attached to it can be moved precisely towards an individual unit to be gripped.

In particular in the case where no 3D camera but only a 2D camera for layer image recognition or the like is provided, in particular at least one alternative height detection means or height measuring device is provided. Such height detection means can ascertain the height to be approached by the gripper device via, for example, at least one laser, radar, ultrasound and/or the like to.

Preferably, the approach accuracy of the gripper device in all and/or individual planes can be taught or improved via at least one AI application (artificial intelligence). In particular, neural networks and/or machine learning and/or deep learning methods can be used. After teaching, the gripper device can preferably also work accurately offline, thus, without AI in the background.

Preferably, at least one further unit, at least one depositing support, in particular in relation to the further unit, and/or at least one storage surface for at least one stock of individual units are provided. Such a depositing support can be provided, for example, at a unit to which a gripped individual unit is to be transferred. Such a depositing support can be provided, for example, by a type of inclined run-on slope or plate so that, for example, a gripped individual unit such as an empty sack or an empty sack stack can be optimally deposited on a conveyor device such as a conveyor belt.

The method according to the invention for gripping at least one individual unit, in particular at least one empty sack or at least one empty sack stack, using a system as described above, is characterized by the following steps in a suitable sequence. The gripper unit of the gripper device is brought up to an edge of the individual unit to be gripped by means of handling devices so that the contact section of the gripper unit is situated next to the individual unit and the holder element of the holder device is situated at least in sections above the individual unit. The gripper device is lowered further such that the contact section of the gripper unit rests next to the individual unit to be gripped or at least almost rests or is situated next to the individual unit and that the holder element rests on the individual unit. By means of the lifting device, at least the edge of the individual unit to be gripped is lifted at least in sections. The contact section is shifted at least in sections so that it is shifted underneath the individual unit to be gripped and the individual unit to be gripped rests on the contact section at least in sections. The individual unit is then clamped or fixed between the fixing device and the contact section.

The fact that the contact section rests next to the individual unit means in particular that the contact section rests substantially on the same plane or in the same plane as the object to be gripped or the individual unit to be gripped. Depending on the configuration, this contact surface can rest completely or only slightly or almost or just not at all.

In particular, the contact section or the gripper device is rotated by means of the handling unit or by means of the robotic arm in such a manner that a specified edge is approached so that the individual units are picked up in a specified or defined or known alignment and, accordingly, can be passed on to another unit or another location.

In general, the gripper device can preferably approach the individual units from any side of the individual unit. This can be particularly advantageous if layer images of individual units are provided in which for at least some individual units there are certain sides that are not freely accessible. For example, when gripping bundles of empty bags, the gripper device can preferably approach them from the long side and the short side.

Depending on the format of the individual units to be gripped, the distance between the gripper unit or contact section or lifting device and the holder section or holder element can preferably be changed and/or adjusted.

The method according to the invention also offers the advantages already described above for gripper devices. In particular, it is possible for complex individual units such as empty sack stacks to be picked up in a specific orientation and transferred to another unit in a defined manner.

Preferably, lifting at least in section and shifting at least in sections takes place in parallel, at least in sections. In particular when using a roller as a lifting device, this roller can be rotated to lift the individual unit, for example when flipping through individual sacks of a stack of sacks, wherein the rotation can also be continued during the shifting of the contact section underneath the individual unit.

Particularly preferably, the shifting of at least the contact section is carried out at least partially by a movement of the robotic arm. Depending on the configuration, the holder unit or the holder element or the holding roller can be moved or shifted over the individual unit in accordance with the shifting of the robotic arm.

In useful configurations, the shifting of at least the contact section is at least partially carried out by a relative movement between the gripper unit and the holder unit. The relative movement can be provided in addition to the movement of the robotic arm or exclusively. A relative movement of the contact section, for example in the direction of the holder unit, causes the contact section to be shifted underneath the individual unit.

Preferably, the gripper unit and the holder unit are in an articulated relation to each other, and the gripper unit and the holder unit are in a first end position when the gripper unit of the gripper device is in the lifted state, and the gripper unit and the holder unit are in a second end position when the gripper device is in the attached state. This can be used, for example by means of end position detection, to detect an optimum position of the gripper device to start lifting the individual unit.

Preferably, the lifting device comprises at least one roller, the lifting being effected by rotation of the roller. A roller can be designed in particular in a manner as described above. The direction of rotation is provided in particular in such a manner that an upward movement of the object or the individual unit or the individual objects of the individual unit is effected.

In useful further developments, at least one camera device is provided by means of which the position and/or orientation of the individual unit to be gripped is detected.

As a result, it is in particular possible to detect which individual unit lies as the top individual unit on or in an individual unit stock or a stock of individual units. In addition, when gripping individual sacks or a stack of sacks, for example with valve sacks, it can be detected on which side the valve is present so that the individual sack or the stack of sacks with the valve can be transferred in a specified orientation to another unit. A controller then preferably actuates the handling device accordingly and transfers the individual unit to another unit.

Further advantages and features of the present invention are apparent from the exemplary embodiment which is explained below with reference to the accompanying figures.

In the figures:

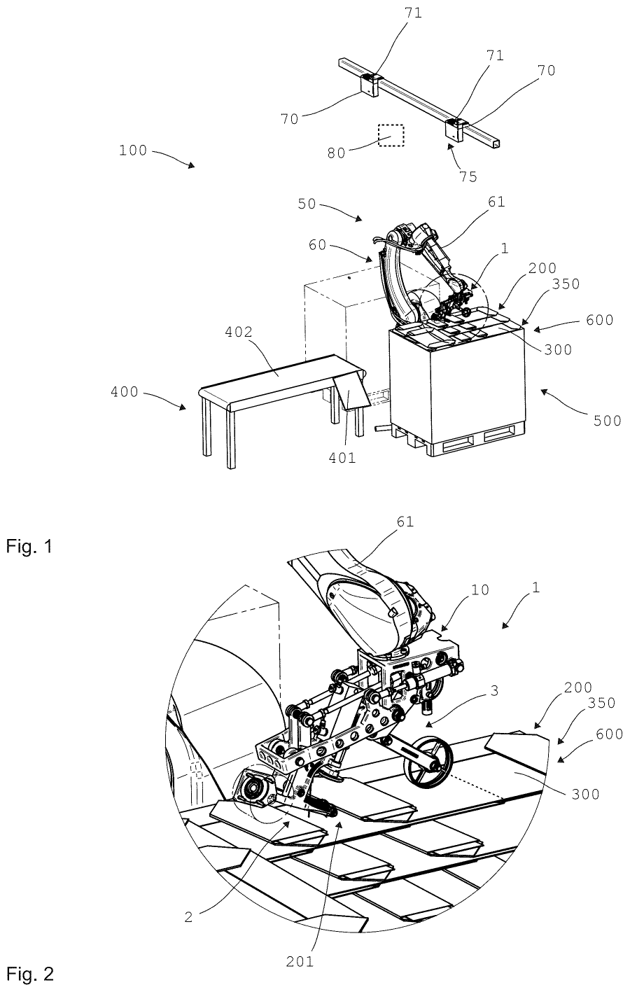

FIG. 1 shows a purely schematic diagram of an exemplary embodiment of a system according to the invention in a perspective view;

FIG. 2 shows a purely schematic enlarged diagram as shown in FIG. 1;

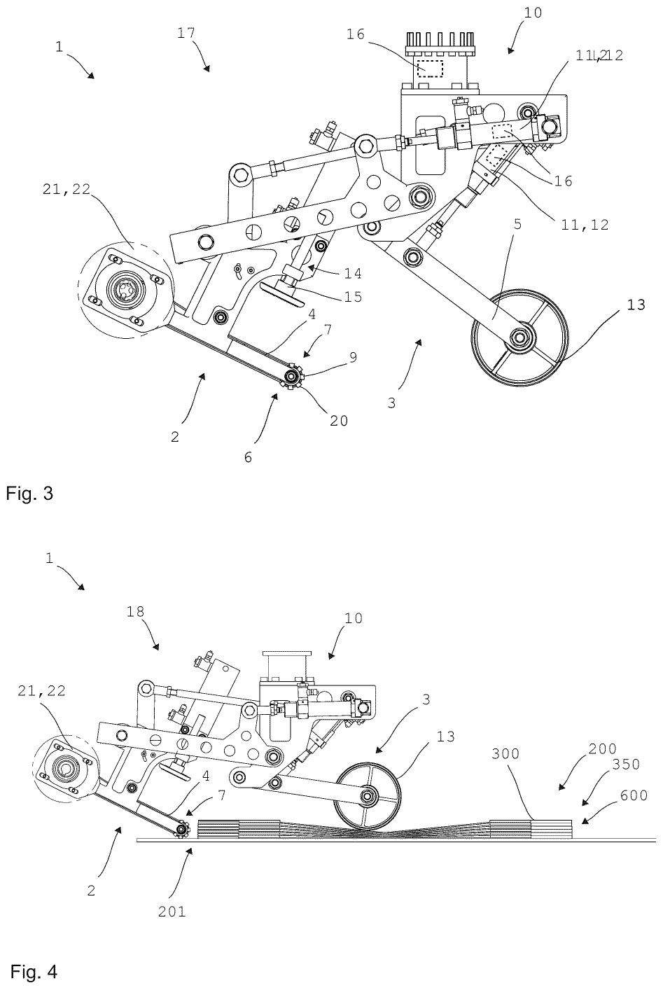

FIG. 3 shows a purely schematic diagram of an exemplary embodiment of a gripper device according to the invention in a side view;

FIG. 4 shows a purely schematic diagram of an exemplary embodiment of a gripper device according to the invention in a side view when gripping an individual unit;

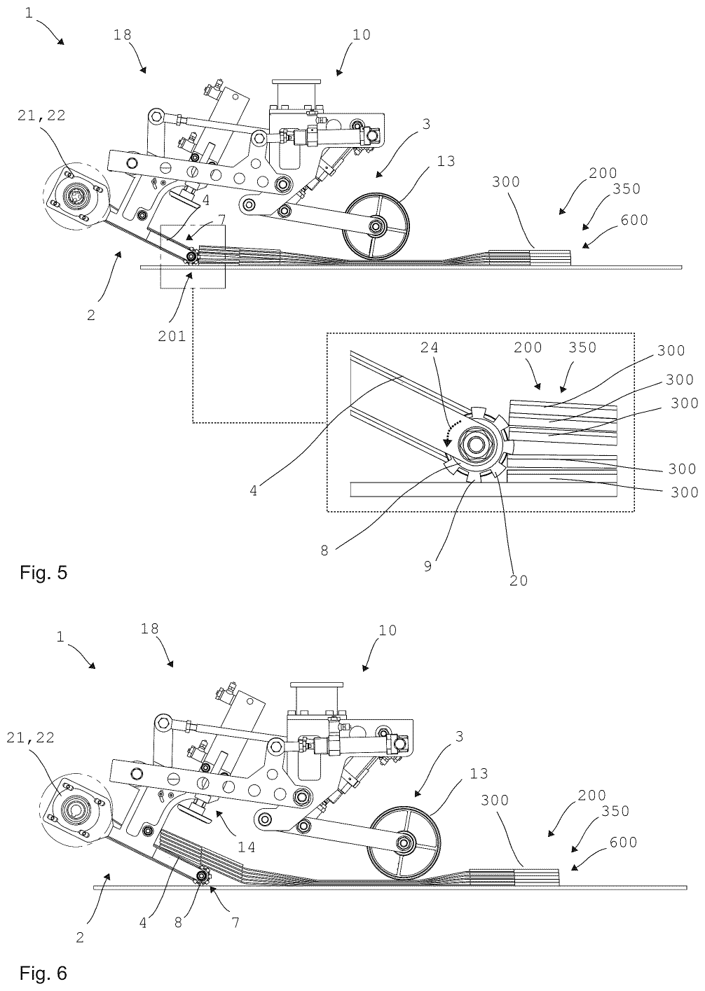

FIG. 5 shows a purely schematic diagram of an exemplary embodiment of a gripper device according to the invention in a side view when gripping an individual unit;

FIG. 6 shows a purely schematic diagram of an exemplary embodiment of a gripper device according to the invention in a side view when gripping an individual unit;

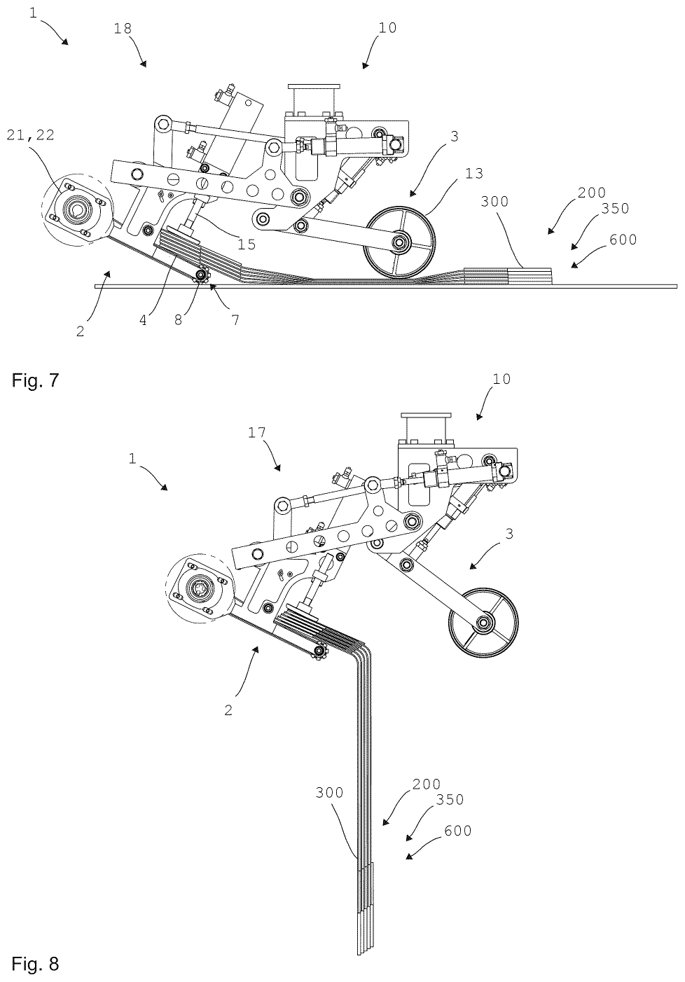

FIG. 7 shows a purely schematic diagram of an exemplary embodiment of a gripper device according to the invention in a side view when gripping an individual unit;

FIG. 8 shows a purely schematic diagram of an exemplary embodiment of a gripper device according to the invention in a side view when gripping an individual unit;

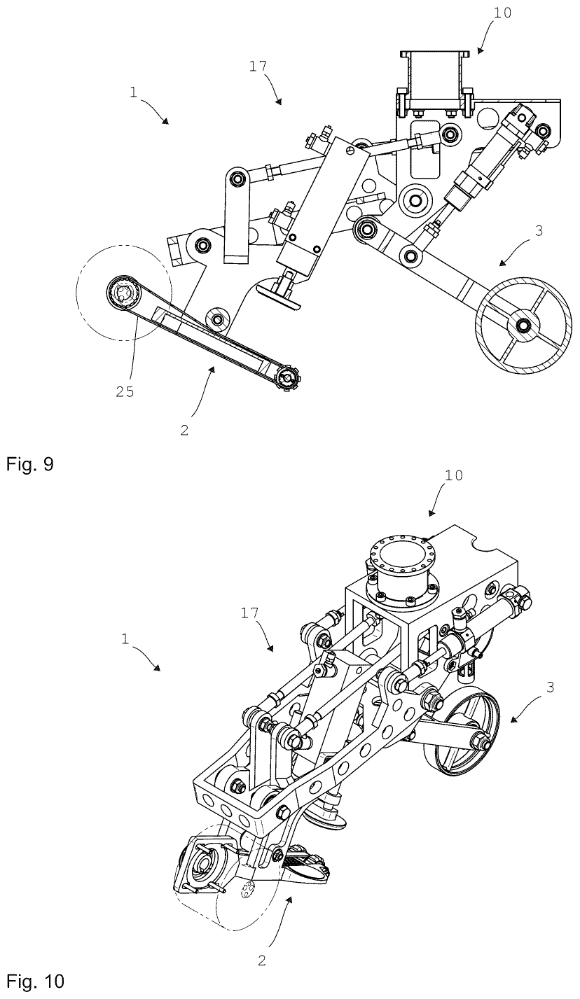

FIG. 9 shows a purely schematic diagram of an exemplary embodiment of a gripper device according to the invention in a sectional view from the side;

FIG. 10 shows a purely schematic diagram of an exemplary embodiment of a gripper device according to the invention in a perspective view;

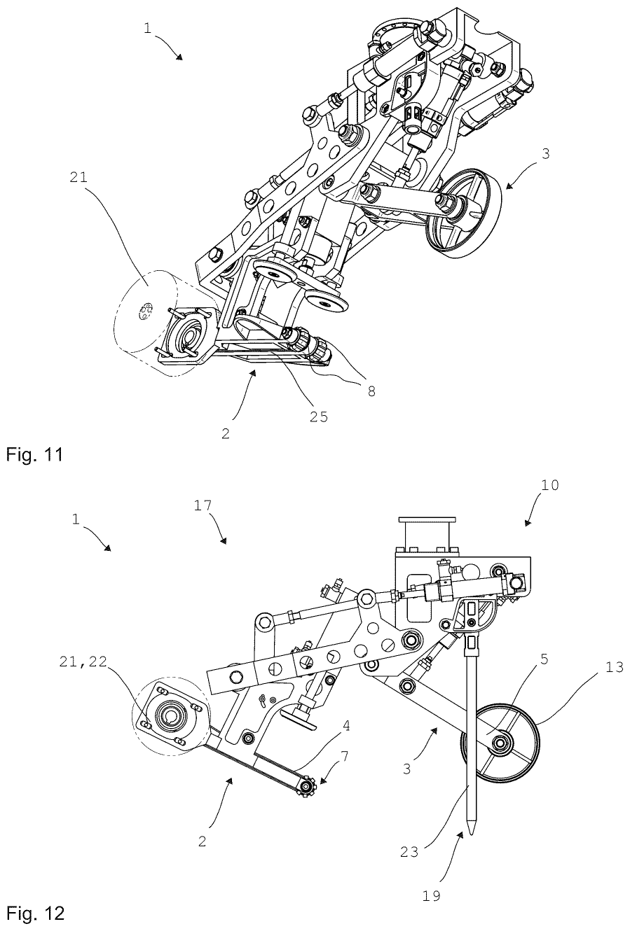

FIG. 11 shows a purely schematic diagram of an exemplary embodiment of a gripper device according to the invention in a further perspective view;

FIG. 12 shows a purely schematic diagram of an exemplary embodiment of a gripper device according to the invention in a sectional view from the side;

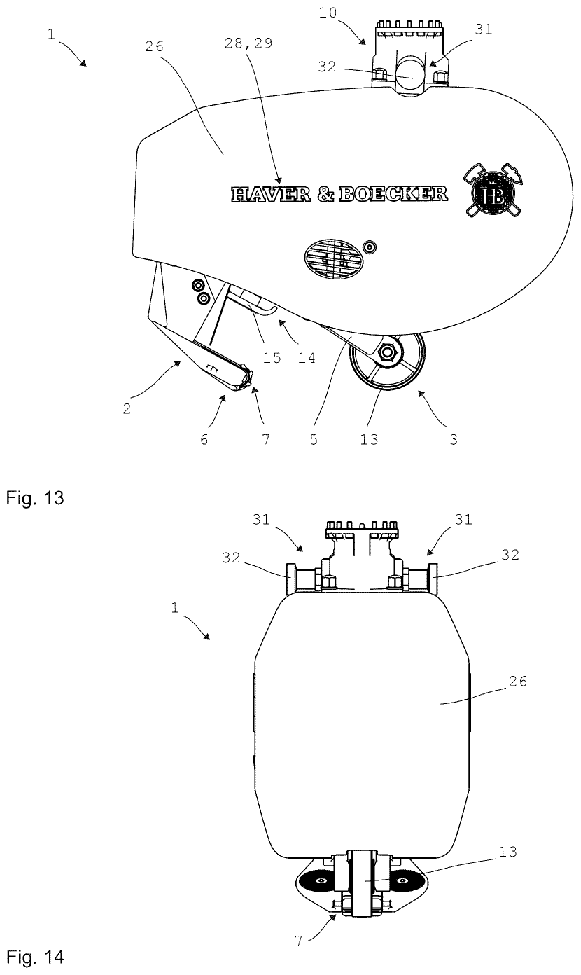

FIG. 13 shows a purely schematic diagram of a further exemplary embodiment of a gripper device according to the invention with a hood device in a side view;

FIG. 14 shows a purely schematic diagram of the exemplary embodiment according to FIG. 13 in a frontal view;

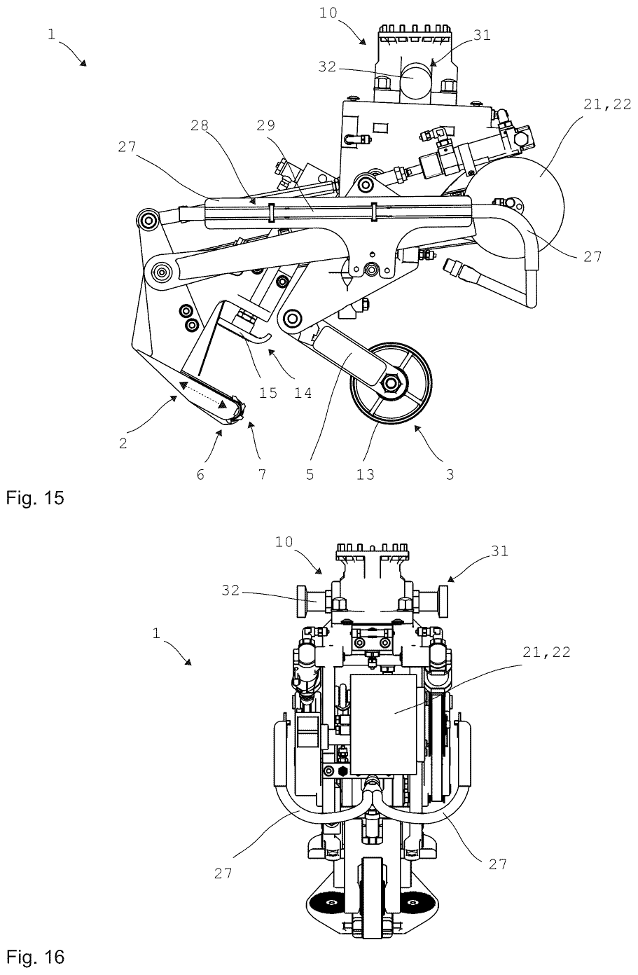

FIG. 15 shows a purely schematic diagram of a next exemplary embodiment of a gripper device according to the invention in a side view;

FIG. 16 shows a purely schematic diagram of the exemplary embodiment according to FIG. 13 in a frontal view;

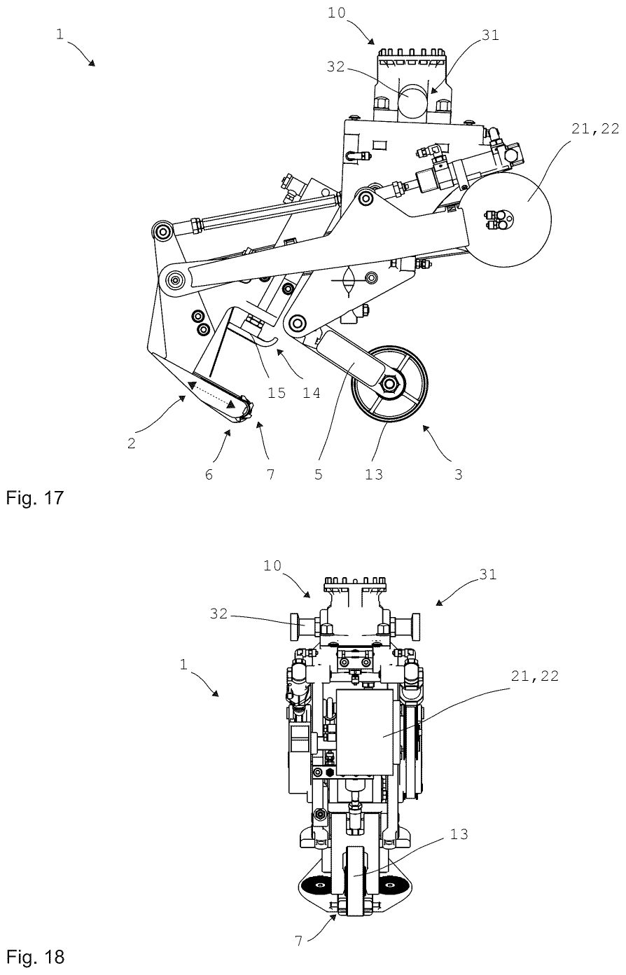

FIG. 17 shows the view according to FIG. 15 without fastening device for a hood device;

FIG. 18 shows the view according to FIG. 16 without fastening devices for a hood device;

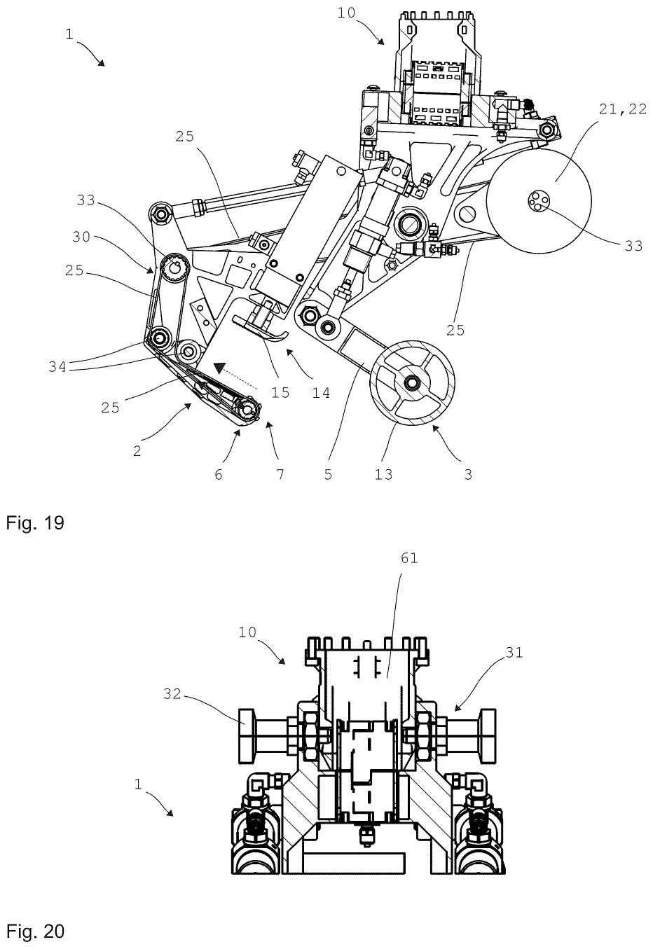

FIG. 19 shows a purely schematic sectional view of the exemplary embodiment according to FIG. 17; and

FIG. 20 shows a purely schematic sectional view of an exemplary embodiment example of a receiving unit with a quick-change device.

FIG. 1 purely schematically illustrates a system 100 according to the invention, which in the exemplary embodiment shown here comprises a handling device 50 and a controller 80. In the exemplary embodiment shown, the system according to the invention is used for gripping and transferring at least one individual unit 200 out of a stock of stacked individual units 200 from a storage surface 500 to a further unit 400. In the exemplary embodiment shown, the individual units are stacked in a layered manner on a pallet and thus provide a stock of individual units 200.

An individual unit 200, for example, is in particular a flat object which is stacked as stock and rests on the storage surface 500. However, an individual unit 200 can also be a stack or bundle 600 of objects, as in the example shown here, with the bundle or stack 600 then being gripped and transferred as an individual unit 200.

What is to be understood by an individual unit according to the application is further defined by way of example in the general description.

In the exemplary embodiment shown, the stacked objects are empty sacks 300, an individual unit 200 being provided here by a stack of sacks 350. In particular, stacks or empty sack stacks 350 of valve sacks are transferred from a pallet on the storage surface 500 to a further unit 400 by means of the handling device 50. In the exemplary embodiment shown, the further unit 400 is a conveyor belt 402 onto which the individual units 200 or the empty sack stacks 350 are transferred in a specified orientation, namely with the valve in a specified orientation on the conveyor belt 402. In the exemplary embodiment shown, this conveyor belt 402 is used to feed empty sacks 300 or individual empty sack stacks 350 to an automatic sack applicator which is connected upstream of a rotary packing system. The bag applicator and the packing system are not illustrated in the embodiment shown here.

In order to facilitate the placing of the gripped individual units 200 onto the conveyor belt 402 or to make it as accurate as possible, a depositing support 401 is provided here, which is designed here as an obliquely mounted plate.

To check the handling device 50 for correct transfer of the individual unit 200 to the further unit 400, or here to the conveyor belt 402, at least one further camera, which is not shown here, can be provided, depending on the configuration. The images or data from this camera can be used, for example, to check whether the orientation of the individual unit during the transfer is actually correct and/or whether individual empty sacks 300 have slipped during the transfer of an empty sack stack 350, for example. If an incorrectly gripped individual unit 200 and/or a faulty individual unit 200 is detected, it can then be transferred to an ejection point, for example. In this manner it can preferably be ensured, among other things, that only those individual units are transferred that can be processed further.

Depending on the configuration, it is then also possible, for example, to check whether the storage location for the individual unit 200 being gripped is free or still occupied. Depending on the detection area of the camera device 70, however, checking the transfer of the individual units 200 to the further unit 400 can also be carried out via this camera 70.

In the exemplary embodiment shown here, 50 comprises a robot 60 with a robotic arm 61, wherein a gripper device 1 according to the invention is attached to the free end of the robotic arm 61.

In order to be able to transfer a gripped individual unit 200 in a defined orientation by means of the handling device 50 to the further unit 400 or to a further location 400, the uppermost and thus exposed individual unit must first be known or detected in order to make sure not to grip individual units that are partially covered by other individual units 200. The gripper device 1 must then grip the uppermost or an exposed individual unit 200 in a defined manner at a specific edge 201, for which purpose the controller 80 must detect the position and/or orientation of the individual unit 200 on or in the stock of sacks or the stock of individual units 200 in order to actuate the gripper device 1 accordingly.

For this purpose, it is provided in the exemplary embodiment shown that a camera device 70 is provided above the storage surface 500, wherein the controller 80 detects the position and/or the orientation of the individual unit 200 to be gripped on the storage surface 500 via the evaluated data of the camera device 70. In the exemplary embodiment shown, the orientation is the orientation with respect to the position of the valve of the valve sack.

To make sure that the gripper device 1 can also approach the appropriate individual unit 200 at the correct height, a height detection means 75 is provided so that the robotic arm 61 can move the gripper device 1 precisely towards the correct individual unit 200 from a specified side or to the correct edge 201 of the correct individual unit 200.

Depending on the configuration, the height detection means 75 can be provided as a separate component, in particular if the camera device 70 itself cannot detect the height or distance to an individual unit 200. In the exemplary embodiment shown here, the camera device 70 is provided by a 3D camera 71 in which, accordingly, a height detection means 75 is integrated.

In the exemplary embodiment shown here, it is also shown that two storage surfaces 500 are arranged in operative connection with the handling device 50, with one storage surface 500 being provided here to the left and one to the right of the robot 60.

The handling device 50 can pick up individual units 200 from both storage surfaces 500, for example alternately or one after the other, and feed them to a unit and/or also supply two separate units with individual units 200 in parallel.

To make sure that the control of the gripper device 1 can precisely grip the respective individual unit 200, a camera device 70 is provided above each storage surface 500 in the exemplary embodiment shown here, both of which are designed here as a 3D camera 71.

Depending on the detection range of the camera device 70 used, it is also possible that only one camera device 70 is provided. In other embodiments it is also conceivable to use only one camera device 70 which is provided to be movable above the storage surfaces 500.

By means of the method according to the invention, the position and/or the orientation of the individual unit 200 to be gripped is ascertained by means of the controller. As already explained above, this means in particular that the controller 80 ascertains the position and/or the orientation of the individual units 200 on the storage surface, for example by means of acquired sensor data or, in the exemplary embodiment shown here, by means of the data of a camera device 70.

Depending on the embodiment, however, ascertainment by means of the controller is also possible in such a manner that, e.g., a specified layer pattern, for example of individual units 200 stacked on pallets in an offset manner, is entered into the controller 200, with the individual specified positions being scanned by means of the controller 80.

The advantage of automatic detection of the sack position or the position or orientation of an uppermost exposed individual unit 200 is that, for example, individual units 200 that are shifted during transport or individual units 200 that are subsequently placed by an operator are detected during automatic detection, so that errors cannot occur.

Ascertainment by means of the controller can also be achieved in that an operator, manually or by hand, informs the controller of a specific approach position.

FIG. 2 shows a purely schematic enlargement of the free end of the robotic arm 61 with the gripper device 1 according to the invention attached to it.

It is illustrated here that the gripper device 1 is received on the robotic arm 61 by means of a receiving unit 10, whereby the robotic arm 61 can move the gripper device 1 in any three-dimensional direction and can also rotate the gripper device 1 so that the gripper unit 2 of the gripper device 1 can be moved towards a specified side or to a detected edge 201 of the individual unit 200 to be gripped.

In the exemplary embodiment shown, the individual units 200 are empty sack stacks 350, here in particular valve sacks, which are present stacked in bundles 600 on a pallet. Thus, the individual unit 200 consists here of a bundle or stack 600 of empty sacks 300.

In the exemplary embodiment shown here, the gripper device 1 comprises a gripper unit 2 and a holder unit 3, wherein the gripper unit 2 and the holder unit 3 are connected to one another in an articulated manner by means of the receiving unit 10 in the exemplary embodiment shown here.

As already described above, the gripper device 1 is received on a robotic arm 61 or on a handling device 50. In the exemplary embodiment shown, the gripper unit 2 comprises a contact section 4 on which an individual unit 200 to be gripped and then to be transferred rests and is clamped by means of a fixing device 14. In the exemplary embodiment shown here, the fixing device 14 comprises a fixing punch 15.

At the free end 6 of the contact section 4, a lifting device 7 is provided which in the exemplary embodiment shown here comprises a roller 8 or two rollers 8 arranged parallel to one another, which can be driven or rotated by means of a motor 21. In this case, a compressed air motor 22 is provided, which can drive the roller 8 in a specified direction 24 or, depending on the configuration, can also rotate the roller in both directions.

The motor is in operative connection with the roller 8. Any suitable power transmission can be used. Here, the roller 8 or the rollers are connected to the motor 21 via a toothed belt 25 in order to effect a transmission of force or rotation to the roller 8. Depending on the configuration, multiple toothed belts and/or other power transmission means can also be provided. Thus, it is also possible to arrange the motor 21 at almost any location via multiple toothed belts or the like, for example to obtain a better weight distribution and/or to have fewer interfering contours when approaching an individual unit 200.

In the exemplary embodiment shown, the roller 8 comprises a contact-imparting structure 9, which is designed here as a type of external toothing or as nubs or grooves. In addition, in the exemplary embodiment shown, the roller 8 comprises a friction- or adhesion-enhancing surface 20. In the exemplary embodiment shown, this surface is provided by a rubber coating.

Depending on the configuration, it can also be sufficient to provide only a contact-imparting structure 9 or only an adhesion-enhancing surface 20.

How the lifting device 7 lifts an individual unit 200 to be gripped so that the contact section 4 can be shifted under the individual unit 200 to be gripped is explained in more detail in the following figures.

In the exemplary embodiment shown here, the holder unit 3 comprises a holder element 5, with a holding roller 13 being provided at the free end of the holder element 5. The function of the holder element 5 or the holding roller 13 is explained in more detail in the following figures.

In addition, the individual elements or units of the gripper device 1 in the exemplary embodiment shown are partially equipped or connected with actuators 11, the actuators 11 being provided here by pneumatic cylinders 12. As a result, it is possible that the gripper device 1 or the arrangement of gripper unit 2 and holder unit 3 in the exemplary embodiment shown are in a first end position 17 in the freely suspended state, and that the gripper device 1 or the gripper unit 2 and the holder unit 3 are in a second end position 18 during the picking up or gripping of an individual unit 200. In the exemplary embodiment shown, the corresponding positions 17, 18 can be detected via a limit switch 16. As indicated in the figure, the limit switch 16 can be provided, for example, on the holder unit 10 and/or on at least one actuator 11 such as a pneumatic cylinder 12. When arranged on a pneumatic cylinder 12, for example, the retraction of the pneumatic cylinder 12 or a certain end position 17, 18 can be detected by the fact that the piston rod of the cylinder 12 passes sensors and thereby triggers the limit switch 16.

FIG. 3 shows the freely suspended configuration of a gripper device 1 according to the invention, wherein in this state, the gripper device 1 approaches an individual unit 200 to be gripped.

The gripper device 1 can approach the individual unit from any side of the individual unit. This can be particularly advantageous if layer images of individual units 200 are provided in which certain sides of at least some individual units 200 are not freely accessible.

Depending on the format of the individual units 200 to be gripped, the distance between the gripper unit 2 or contact section 4 or lifting device 7 and holding section 3 or holder element 5 can then also be changed and/or adjusted.

First of all, the position and/or orientation of an individual unit 200 to be gripped in a stock of individual units 200 on a storage surface 500 is ascertained or detected in the manner described above in accordance with the invention. In this manner, the contact section 4 can be moved next to a specified side or next to a specified edge 201 of the individual unit 200 to be gripped.

Since the individual unit 200 is gripped from a defined side or from a defined edge 201, it can also be transferred in a defined manner to a further unit 400, so that, for example, in the exemplary embodiment shown, valve sacks can be placed on a conveyor belt 402 with a certain orientation so that the individual sacks 300 can be transferred to a sack applicator with the valve in a defined position.

Once the position and/or orientation of an individual unit 200 to be gripped has been detected, the gripper device 100 is moved by means of the robotic arm 100 in the correct orientation towards an individual unit 200 to be gripped until the gripper unit 2 or the contact section 4 is present next to the individual unit 200 to be gripped on the corresponding specified side or next to the specified edge 201. In this state, the holder unit 3 or the holder element 5 is located above the individual unit 200 to be gripped and the gripper device 1 is still in the first end position 17 in the exemplary embodiment shown here. This position is ascertained in this exemplary embodiment via the evaluation of the camera images and/or the height detection means 75.

In all configurations, the approach accuracy of the gripper device in all and/or individual planes can be taught and/or improved preferably via at least one AI application (artificial intelligence), depending on the design. In particular, neural networks and/or machine learning and/or deep learning methods can be used for this purpose. After the teaching, the gripper device (1) can then preferably also work accurately offline, i.e., without AI in the background,

FIG. 4 shows that the gripper device 1 is subsequently lowered further until the contact section 4 rests on the same plane, in particular with a specified force, as the individual unit 200 to be gripped, wherein depending on the configuration, the contact section 4 may not be present completely and/or may be slightly spaced from the contact plane of the individual unit 200. In this position, the gripper device 1 is in the second end position 18, which is detected here by the limit switch 16. Depending on the configuration, however, the second end position 18 can also be detected by the height detection means 75.

As the gripper device 1 continues to move down, the holder element 5, or, in the exemplary embodiment shown, the holding roller 13 comes into contact with the individual unit 200 to be gripped, thereby shifting the position of the gripper unit 2 and holder unit 3 to the second end position 18.

Depending on the configuration, the controller 80 or a limit switch 16 can detect through the second end position 18 that the gripper device 1 cannot or must not be moved down any further.

In FIG. 5, the overall view and the enlarged view show the free end 6 of the contact section 4 with the roller 8. It is illustrated how the lifting device 7 lifts the individual unit 200 to be gripped so that the contact section 4 can be shifted under the individual unit 200 to be gripped.

For this purpose, the roller 8 in the exemplary embodiment shown here or in the view shown here is rotated counterclockwise in the specified direction of rotation 24 by means of the motor device 21, so that the contact-imparting structure 9 or the adhesion-enhancing surface 20 flips through the individual objects or here empty sacks 300 of the empty sack stack 350 or the individual unit 200, so to speak, and thereby lifts them. In this case, the preferred direction of rotation 24 is provided in such a manner that it results in an upwardly directed effective direction such that the individual unit 200 is moved upwards and the contact section 4 can be shifted under the individual unit 200.

In FIG. 6, it can be seen that after lifting and, depending on the configuration, also during lifting, the robotic arm 61 moves the gripper device 1 to the right in the exemplary embodiment shown, whereby the contact section 4 is shifted under the individual unit 200 to be gripped. The shifting is supported or simplified here by the fact that the holder element 5 comprises a holding roller 13, which rolls over the individual unit to be gripped in accordance with the shifting of the gripper device 1 by means of the robotic arm 61.

As can be seen, the individual unit 200, in this case the empty sack stack 350, is preferably at least slightly flexible so that it bends slightly by pressing it down by means of the holder element 5 or the holding roller 13 and by lifting it by means of the lifting device.

Depending on the configuration, the lifting device 7 or the roller 8 can also be further rotated or driven to 100 during the shifting of the contact section 4 under the individual unit to be gripped, should this be necessary. This supports the placement of the individual unit 200 onto the contact section 4.

As already shown in FIG. 6, FIG. 7 shows that the contact section 4 has been shifted under the individual unit 200 to be gripped so that the individual unit 200 or the edge section thereof rests on the contact section 4 of the gripper unit 2.

In order for the gripper device 1 to be able to also lift the individual unit 200 or here the empty sack stack 350, a fixing device 14 with a fixing punch 15 is provided in the exemplary embodiment shown, which here clamps the individual unit 200 on the contact section 4.

FIG. 8 shows that the robotic arm 61 lifts the gripper device 1 including the gripped individual unit 200, whereby the individual unit 200 now hangs on the contact section 4. In this manner, the individual unit 200 can be transferred.

By lifting the gripper device 1, the first end position 17 of gripper unit 2 and holder unit 3 is again assumed in the exemplary embodiment shown. The robotic arm 61 or the gripper device 1 can now move and/or rotate in such a manner that the gripped individual unit 200 is transferred to another unit 400 in a specified orientation.

In FIGS. 9 to 11, a lateral sectional view and two perspective views of exemplary embodiments of gripper devices 1 according to the invention are shown purely schematically in order to illustrate a possible configuration of gripper devices 1 according to the invention in even greater detail.

FIG. 12 shows purely schematically that the gripper device 1 can comprise a referencing device 19, which is designed as a rod 23 in the exemplary embodiment shown here.

This referencing device 19 is used here for the initial installation of the system 100, wherein an initial alignment, in particular between height detection means 75 or 3D camera 71 and handling device 50 can be carried out by means of the referencing device 19. In particular, by means of the referencing device 19 placed onto a specified surface, it can be detected by means of the controller 80 which height the gripper device 1 has assumed when the height detection means 75 detects a certain height.

In addition, a movement adjustment can be carried out or an interference contour during the rotation of the gripper device 1 can be adjusted by means of a referencing device 19 so that the controller 80 can prevent a collision with other components, individual units, and/or objects during movement and also during rotation, in particular during simultaneous movement and rotation.

FIGS. 13 and 14 show in purely schematic views from the side and front a further exemplary embodiment of a gripper device 1 with a hood device 26, which here provides a protective hood.

This hood device 26 protects the mechanics of the gripper device in particular against dust, or dirt, and collisions. As a result, in the exemplary embodiment shown, maintenance intervals can be extended and in the event of a collision, only the hood device 26 is usually damaged and not the sometimes sensitive mechanics of the gripper device 1.

In the exemplary embodiment shown here, a display device 28 with an illumination device 29 is assigned to the hood device 26 or these components are comprised by the hood device 26. Here, a display device 28 in the form of an illumination device 29 is arranged behind the hood device 26, which, through the logo which is transparent here, provides a status display on the sides of the gripper device 1. Depending on the status, the logo can then be illuminated in different colors.

The display device 28 or the lighting device 29 can be integrated, for example, into a fastening device 27 of the hood device 26, which is covered here by the hood device 26 or is assigned to it.

The receiving unit 10, by means of which the gripper device 1 can be fastened, e.g., to a robotic arm, comprises a quick-change device 31 in the exemplary embodiment shown here so that the entire gripper device can be installed and uninstalled quickly and easily by actuating the bolt or bolt 32.

In the exemplary embodiment shown, the hood device 26 does not cover the quick-change device so that the gripper device can also be changed and installed with the hood device being installed.

FIGS. 15 and 16 show purely schematic views from the side and front of a next exemplary embodiment of a gripper device 1.

In this exemplary embodiment, too, a hood device 26 can be installed. For this purpose, the gripper device 1 comprises a fastening device 27, or fastening devices 27 are provided on the left and right sides of the gripper device 1.

In the exemplary embodiment shown, the fastening devices 27 comprise a display device 28 or an illumination device 29. With a correspondingly designed hood device 26, a status display as shown in FIGS. 13 and 14 can then be achieved, for example.

The basic structure of the gripper device 1 or the gripper unit 2 and the holder unit 3 is very similar to the exemplary embodiments shown in FIGS. 3 to 13. However, in the exemplary embodiment shown here, the motor 21 or the compressed air motor 22 is not provided directly on the contact section 4, but in relation thereto downstream and below the receiving unit 10. In order to drive the rollers 8 of the lifting device 7, a deflection device 30 is provided which transmits the rotation of the motor 21 to the rollers 8 by means of multiple belts 25 or toothed belts and drive shafts 33 and deflection rollers 34.

Furthermore, it is indicated in FIG. 15 by the dashed double arrow that in all exemplary embodiments, the contact section 4 can be telescopic and/or that a certain length compensation can be achieved in a different manner. Thus, the contact section 4 can be optimally adapted to the dimensions of an individual unit 200 to be gripped, for example an empty sack 300 or an empty sack stack 350.

In FIGS. 17 and 18, the exemplary embodiment according to FIGS. 14 and 15 is again shown in a purely schematic view from the side and in a front view.

In these illustrations, the fastening device 27 for the hood device 26 is not shown in order to show the components therebehind.

In FIG. 19, the view according to FIG. 17 is again shown in a sectional view in which the deflection device 30 is easier to identify.

In FIG. 20, a sectional view through the receiving unit 10 of an exemplary embodiment of a gripper device 1 with a quick-change device 31 is shown.

Here, the spring-loaded bolts 32 can be seen, which are pulled out to the left and right to change the gripper device 1, causing the gripper device 1 to detach from a robotic arm 61, for example.

Reference list

| | |
|---|---|
| 1 | gripper device |
| 2 | gripper unit |
| 3 | holder unit |
| 4 | contact section |
| 5 | holder element |
| 6 | free end |
| 7 | lifting device |
| 8 | roller |
| 9 | contact-imparting structure |
| 10 | receiving unit |
| 11 | actuator |
| 12 | pneumatic cylinder |
| 13 | holding roller |
| 14 | fixing device |
| 15 | fixing punch |
| 16 | limit switch |
| 17 | first end position |
| 18 | second end position |
| 19 | referencing device |
| 20 | adhesion-enhancing surface |
| 21 | motor |
| 22 | compressed air motor |
| 23 | rod |
| 24 | direction of rotation |
| 25 | toothed belt |
| 26 | hood device |
| 27 | fastening device |
| 28 | display device |
| 29 | illumination device |
| 30 | deflection device |
| 31 | quick-change device |
| 32 | bolt |
| 33 | drive shaft |
| 34 | deflection roller |
| 50 | handling device |
| 60 | robot |
| 61 | robotic arm |
| 70 | camera device |
| 71 | 3D camera |
| 75 | height detection means |
| 80 | control device |
| 100 | system |
| 200 | individual unit |
| 201 | edge |
| 300 | empty sack |
| 350 | empty sack stack |
| 400 | unit |
| 401 | depositing support |
| 402 | conveyor belt |
| 500 | storage surface |
| 600 | bundle/stack |

1. A gripper device for gripping individual units, in particular for gripping an empty sack or an empty sack stack, comprising: at least one gripper unit and at least one holder unit; wherein the gripper unit has at least one contact section for an individual unit to be gripped and wherein the holder unit comprises at least one holder element;
least one free end of the contact section comprises at least one lifting device in order to lift an individual unit to be gripped at least in sections so that the contact section can be shifted at least in sections underneath the individual unit to be gripped, and the gripper unit comprises at least one fixing device in order to clamp an individual unit between the fixing device and the contact section.

2. The gripper device according to claim 1, wherein the lifting device comprises at least one roller.

3. The gripper device according to claim 2, wherein the roller can be driven.

4. The gripper device according to claim 3, wherein the roller can be driven by means of at least one motor, wherein the propulsion of the motor is transmitted to the roller via at least one deflection device.

5. The gripper device according to claim 2, wherein the at least one roller has, at least in sections, at least one contact-imparting structure and/or has, at least in sections, at least one adhesion-enhancing surface.

6. The gripper device according to claim 1, wherein the gripper unit and the holder unit are movable relative to each other.

7. The gripper device according to claim 1, wherein the gripper unit and the holder unit are provided in an articulated and/or resilient relation to each other.

8. The gripper device according to claim 1, wherein the contact section can be telescoped at least in sections and/or is adjustable in length in a different manner.

9. The gripper device according to claim 1, wherein at least one receiving unit is provided, to which the gripper unit and the holder unit are connected.

10. The gripper device according to claim 1, wherein at least one actuator is associated with the gripper unit, the contact section, the holder unit, and/or the holder element.

11. The gripper device according to claim 10, wherein the actuator comprises at least one pneumatic cylinder or the like.

12. The gripper device according to claim 1, wherein the holder element comprises at least one holding roller.

13. The gripper device according to claim 1, wherein at least one limit switch is provided.

14. The gripper device according to claim 1, wherein at least one referencing device is provided.

15. The gripper device according to claim 1, wherein at least one hood device covers at least the gripper unit and at least one holder unit at least in sections.

16. The gripper device according to claim 15, wherein at least one fastening device is provided for the hood device.

17. The gripper device according to claim 15, wherein at least one display device is associated with the hood device.

18. The gripper device according to claim 17, wherein the display device comprises at least one illumination device which in particular is at least partially integrated into the fastening device.

19. A handling device, comprising at least one robot device with at least one robotic arm and at least one gripper device according to claim 1 arranged thereon.

20. A system for gripping and transferring at least one individual unit, in particular at least one empty sack or at least one empty sack stack, comprising at least one handling device according to claim 19 and at least one controller.

21. The system according to claim 20, comprising at least one camera device and/or at least one height detection means.

22. The system according to claim 20, comprising at least one further unit, at least one depositing support and/or at least one storage surface for at least one stock of individual units.

23. A method for gripping at least one individual unit, in particular at least one empty sack or at least one empty sack stack, using a system according to claim 1, including the following steps in a suitable sequence:
bringing the gripper unit of the gripper device, by means of the handling device, to an edge of the individual unit to be gripped so that the contact section is situated next to the individual unit and the holder element of the holding unit is situated at least in sections above the individual unit;
further lowering the gripper device so that the contact section of the gripper unit is situated or rests next to the individual unit to be gripped and that the holder element rests on the individual unit;
lifting, at least in sections, at least the edge of the individual unit to be gripped by means of the lifting device;
shifting, at least in sections, at least the contact section so that this contact section is shifted underneath the individual unit to be gripped and the individual unit to be gripped rests at least in sections on the contact section; and
clamping/fixing the individual unit between the fixing device and the contact section.

24. The method according to claim 23, wherein the lifting at least in section and the shifting at least in sections is carried out in parallel, at least in sections.

25. The method according to claim 23, wherein the shifting of at least the contact section is carried out at least partially by a movement of the robotic arm.

26. The method according to claim 24, wherein the shifting of at least the contact section is at least partially carried out by a relative movement between the gripper unit and the holder unit.

27. The method according to claim 24, wherein the gripper unit and the holder unit are provided in an articulated relation to each other and wherein in the lifted state of the gripper device, the gripper unit and the holder unit are present in a first end position and wherein in the attached state of the gripper device, the gripper unit and the holder unit are present in a second end position.

28. The method according to claim 24, wherein the lifting device comprises at least one roller, wherein the lifting of the individual unit is effected by the rotation of the roller.

29. The method according to claim 24, wherein at least one camera device is provided, by means of which the position and/or the orientation of the individual unit to be gripped is detected.

30. The method according to claim 24, wherein at least one height detection means is provided in order to ascertain the approach height of the gripper device.

31. The method according to claim 24, wherein at least one AI application improves the approach accuracy of the gripper device towards an individual unit to be gripped.
